(19) United States
(12) Patent Application Publication
(10) Pub. No.: US 2009/0120298 A1
(43) Pub. Date: May 14, 2009

(54) AIR FILTER HAVING FUNCTION OF INDICATING CHOKED CONDITIONS

(76) Inventor: Chieh-Yuan CHENG, Shengang Township (TW)

Correspondence Address: SINORICA, LLC, 528 FALLSGROVE DRIVE, ROCKVILLE, MD, 20850, US

(21) Appl. No.: 11/938,287

(22) Filed: Nov. 11, 2007

(51) Int. Cl. B01D 35/143

(52) U.S. Cl. 96/421

(57) ABSTRACT

An air filter having function of indicating choked conditions includes a housing bored with a wind outlet, a wind intake and a peep hole. A filter unit is positioned between the wind outlet and the wind intake, and an exhauster is assembled between the filter unit and the wind outlet. The exhauster has a cover body bored with two air intakes and one exhaust hole communicating with the wind outlet. An air-current sensing unit is disposed between the exhaust hole and the wind outlet, having a basic frame pivotally assembled with a rod having one end combined with an indicating plate in the housing, facing the peep hole and disposed with different marks. A wind-blocking sheet is axially secured on the rod driven by air current to actuate the indicating plate to rotate, convenient to know whether the filter unit is clogged by the marks on the indicating plate.

### BACKGROUND OF THE INVENTION

1. Field of the Invention

This invention relates to an air filter, particularly to one having function of indicating choked conditions of a filter unit.

2. Description of the Prior Art

A conventional air filter having function of indicating choked conditions, as disclosed in a U.S. Pat. No. 6,723,159 shown in FIGS. 2 and 3, is provided with an indicating unit 3 between the wind outlet 11 of a housing 1 and the air outlet 21 of a windmill 2. The indicating unit 3 is provided with a basic frame 31 pivotally assembled thereon with a pivotal rod 32 having its outer end pivotally inserted through the housing 1 and combined with a needle 33 to be actuated by the pivotal rod 32 to shift between a first location 12 and a second location 13 on the surface of the housing 1. The needle 33 is exposed on the surface of the housing 1 so it is likely to be bumped by external force, and dust and impurities are easy to adhere to the joint portion of the needle 33 and the housing 1. In addition, when moved about, the housing 1 will swing and may be bumped, liable to have the joint portion of the needle 33 and the pivotal rod 32 rubbed and loosened and let the needle 33 lose its accuracy. The pivotal rod 32 is combined with a wind-blocking sheet 42, which can be driven to swing by air current flowing from the air outlet 21 to the wind outlet 11 and actuate the needle 33 to shift from the first location 12 to the second location 13 when the filter unit of the air filter is in a non-chocked state. By so designing, if the index 33 is not moved to the second location 13, it means that the filter unit is clogged and has to be replaced or washed clean. Further, conventional air filters are mostly assembled on a high ceiling and hence it is not easy to correctly judge a location indicated by the needle 33, thus resulting in trouble in use.

### SUMMARY OF THE INVENTION

The objective of this invention is to offer an air filter having function of indicating choked conditions, includes a housing bored with a wind outlet and a wind intake and having one side plate bored with a peep hole adjacent to the wind outlet. A filter unit is assembled between the wind outlet and the wind intake of the housing, and an exhauster is positioned between the filter unit and the wind outlet, having a cover body covered thereon. The cover body of the exhauster is bored with two air intakes and one exhaust hole communicating with the wind outlet. An air-current sensing unit is installed between the exhaust hole of the cover body and the wind outlet of the housing and provided with a basic frame pivotally assembled thereon with a rod having its outer end secured with an indicating plate positioned inside the housing and corresponding to the peep hole for protecting the indicating plate from being bumped by external force, and the indicating plate has its surface disposed with different-colored marks. A wind-blocking sheet is axially fixed on the rod to be driven to turn around by air current and actuate the rod to rotate. When the air filter is operated and if the filter unit is not yet clogged, air current sent to the exhaust hole by the exhauster will drive the wind-blocking sheet to move up to a location parallel to the direction of the air current and simultaneously actuate the rod and the indicating plate to rotate. Thus, a user can know whether the filter unit is in a choked condition by watching changes of the different-colored marks on the indicating plate via the peep hole of the housing. Further, a transparent protective plate is covered on the outer side of the peep hole for preventing dust and impurities from adhering to the indicating plate and the gap of the peep hole. Furthermore, the indicating plate is not fixed with the inner wall of the housing, able to avoid the indicating plate swinging and the rod curved and damaged when the air filtration machine is moved about.

### BRIEF DESCRIPTION OF DRAWINGS

This invention will be better understood by referring to the accompanying drawings, wherein:

FIG. 1 is a perspective view of a conventional air filter;

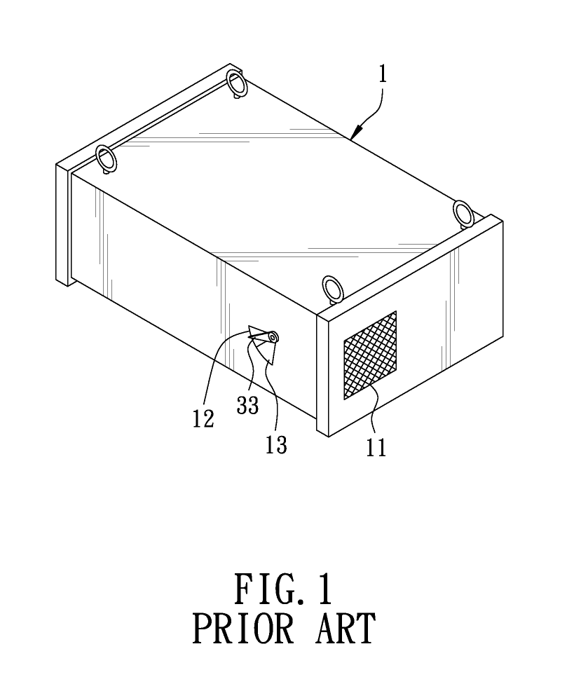

FIG. 2 is a cross-sectional view of the conventional air filter;

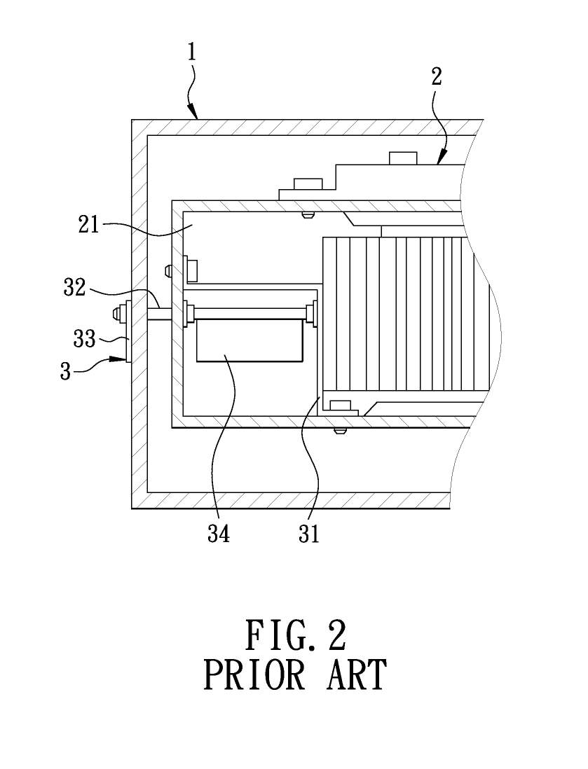

FIG. 3 is an exploded perspective view of an air filter having function of indicating choked conditions in the present invention;

FIG. 4 is a cross-sectional view of the air filter having function of indicating choked conditions in the present invention;

FIG. 5 is a perspective view of an air current sensing unit of the air filter in a first sensing condition in the present invention; and

FIG. 6 is a perspective view of the air current sensing unit of the air filter in a second sensing condition in the present invention.

### DETAILED DESCRIPTION OF THE PREFERRED EMBODIMENT

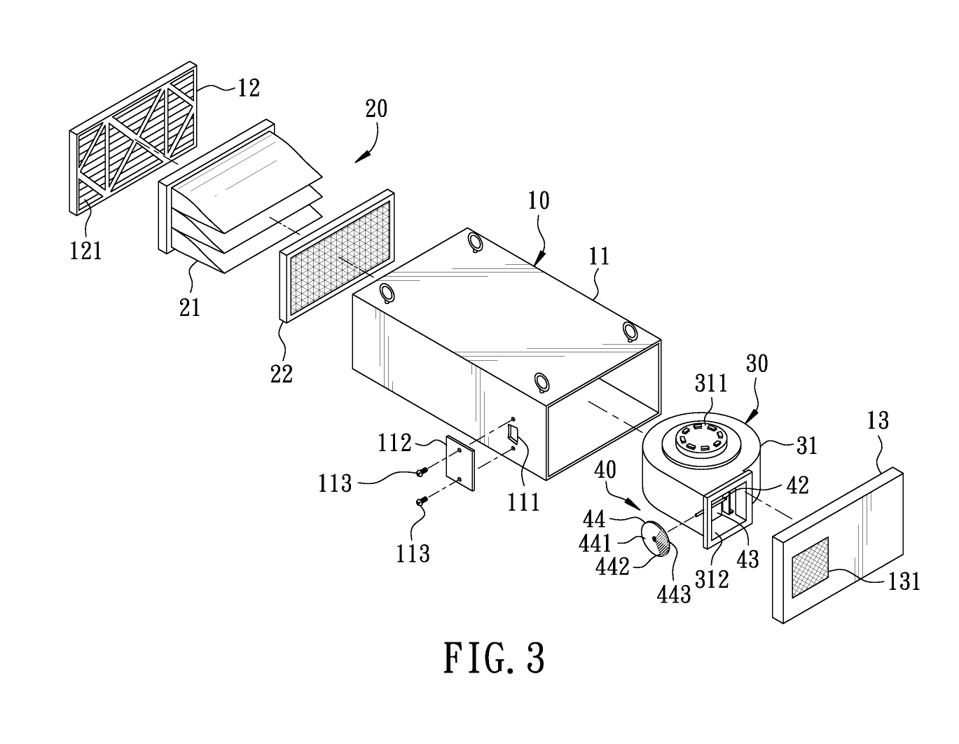

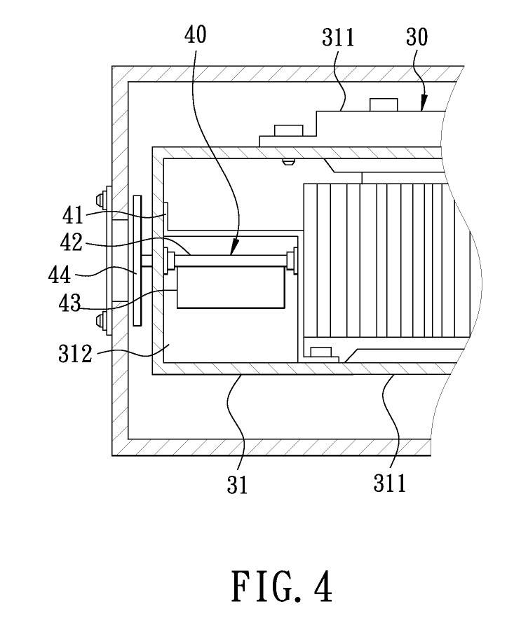

A preferred embodiment of an air filter having function of indicating choke conditions in the present invention, as shown in FIGS. 3 and 4, includes a housing 10, a filter unit 20, an exhauster 30 and an air-current sensing unit 40 combined together.

The housing 10 is provided with a hollow casing 11, a front cover 12 assembled at one open side of the casing 11 and bored with a wind intake 121, and a rear cover 13 assembled at the other open side of the casing 11 and bored with a wind outlet 131. The casing 11 has one side wall bored with a peep hole 111 at a location adjacent to the rear cover 13. The peep hole 111 is arc-shaped and has its surface covered with a transparent protective plate 112 locked in position by two bolts 113, and the interior of the peep hole 111 can be seen through the transparent protective plate 112.

The filter unit 20 assembled in the casing 11 of the housing 10 and positioned between the wind intake 121 and the wind outlet 131 is provided with a filter bag 21 and a filter plate 22. The filter bag 21 is assembled in the casing 11 at a location adjacent to the front cover 12, while the filter plate 22 is positioned at an intermediate portion in the casing 11.

The exhauster 30 is installed in the interior of the casing 11 and positioned between the filter plate 22 of the filter unit 20 and the wind outlet 131 of the housing 10. The exhauster 30 is provided with a cover body 31 secured on the rear cover 13, having its upper and lower side respectively separated from the upper wall and the lower wall of the casing 11. The cover body 31 of the exhauster 30 has its upper and lower end respectively bored with an air intake 311 and is also bored with an exhaust hole 312 at one side connected with the wind outlet 131 of the housing 10.

The air-current sensing unit 40 is assembled between the exhaust hole 312 of the cover body 31 and the wind outlet 131 of the housing 10 and composed of a basic frame 41, a rod 42, a wind-blocking sheet 43 axially connected with the rod 42, and an indicating plate 44. The rod 42 has one end pivotally assembled on the basic frame 41 and the other end inserted through the cover body 31 and secured with the indicating plate 44 corresponding to the peep hole 111 of the housing 10. The indicating plate 44 is disk-shaped and divided into three districts respectively marked thereon with green color 441, yellow color 442 and red color 443. The green color 441 is marked on a district of the indicating plate 44, which can be seen through the peep hole 111 of the housing 10 when the wind-blocking sheet 43 is located parallel to the direction of the air current flowing to the exhaust hole 312. The red color 443 is marked on a district of the indicating plate 44, which can be seen through the peep hole 111 of the housing 10 when wind-blocking sheet 43 is located perpendicular to the air flowing direction of the exhaust hole 312, while the yellow color 442 is marked on a district of the indicating plate, which is located between the two districts of green color 441 and the red color 443.

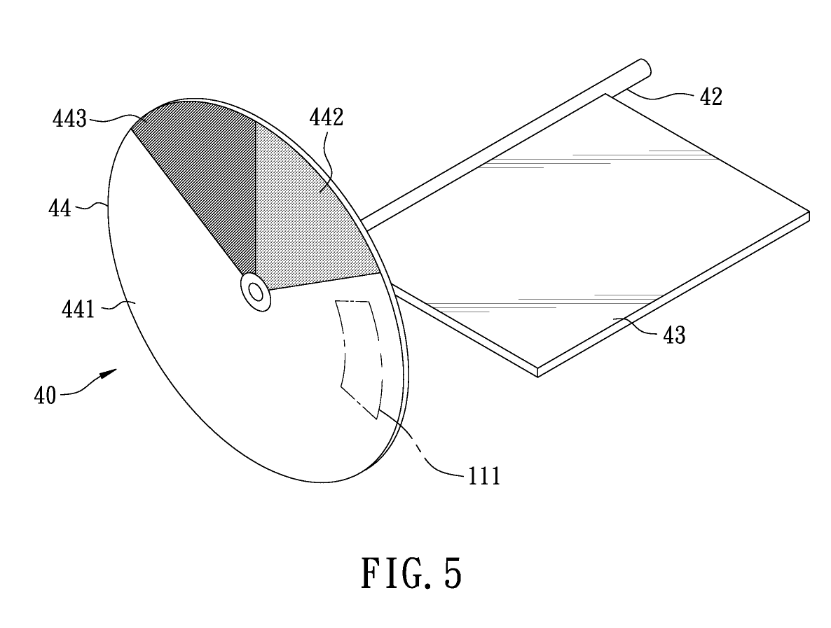

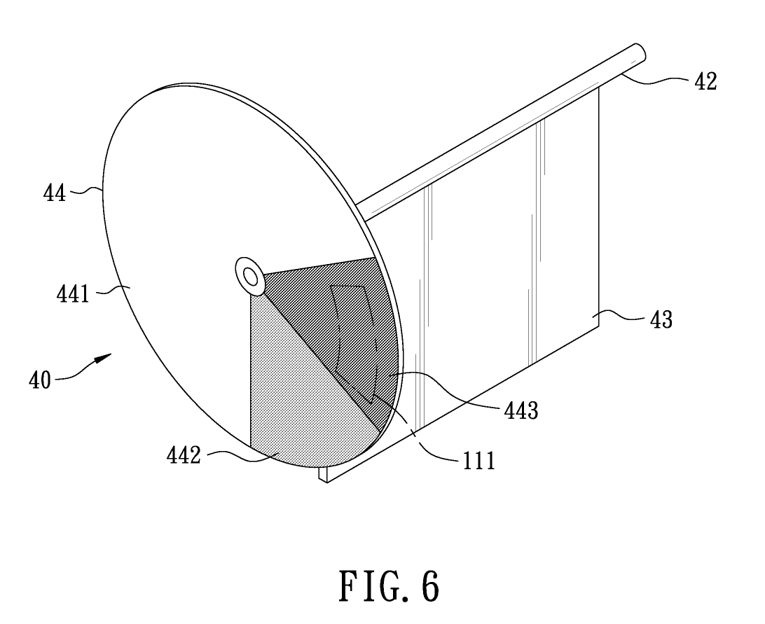

Referring to FIGS. 5 and 6, when the air filter is operated and air current flowing through the filter unit 20 is sucked into the casing 11 by the exhauster 30 through the air intakes 311 of the cover body 31 and then sent to the exhaust hole 312 of the cover body 31, if the filter unit 20 is in a non-choked condition, the air current will be able to drive the wind-blocking sheet 43 to shift to a horizontal location parallel to the air current, and the indicating plate 44 will be actuated by the wind-blocking sheet 43 to rotate and the green color 441 on the indicating plate 44 will be indicated through the peep hole 111. If the filter unit 20 is in a choked condition, the airflow will be unable to drive the wind-blocking sheet 43 to shift and at this time, the wind-blocking sheet 43 will naturally hang down vertically and the indicating plate 44 will indicate red color 443 through the peep hole 111.

To sum up, this invention has the following advantages.

1. Choke conditions of the filter unit of the air filter can be judged according to different colors on the indicating plate in the peep hole; therefore, when a choked condition happens, the filter unit can timely be removed out and washed clean for maintaining good filtering effect and protecting the exhauster from being damaged.

2. Being positioned in the interior of the housing, the indicating plate can avoid being bumped by external force and causing damage.

3. The peep hole is covered with the protective plate, able to prevent dust and impurities from adhering to the indicating plate and the gap of the peep hole.

4. The indicating plate is marked thereon with different bright color clearly visible and distinguished from a distant spot; therefore, a user can know a choked extent of the air filter anytime by watching the colors on the indicating plate through the peep hole, convenient in use.

While the preferred embodiment of the invention has been described above, it will be recognized and understood that various modifications may be made therein and the appended claims are intended to cover all such modifications that may fall within the spirit and scope of the invention.

I claim:

1. An air filter having function of indicating choked conditions, said air filter comprising:
a housing bored with a wind intake and a wind outlet communicating with each other, said housing bored with a peep hole at one side plate adjacent to said wind outlet;
a filter unit assembled in said housing and positioned between said wind intake and said wind outlet;
an exhauster installed in said housing and located between said wind outlet and said filter unit, said exhauster provided with a cover body bored with at least one air intake and one exhaust hole, said exhaust hole communicating with said wind outlet of said housing; and
an air-current sensing unit disposed between said exhaust hole of said exhauster and said wind outlet of said housing, said air-current sensing unit provided with a basic frame pivotaly and horizontally as s em bled thereon with a rod, said rod having one end fixed with an indicating plate to be rotated together with said rod, said indicating plate positioned in said housing and corresponding to said peep hole of said housing, said indicating plate divided into different-colored districts, said rod axially secured thereon with a wind-blocking sheet, said indicating plate rotated together with said rod when said wind-blocking sheet is driven by air current and raised up.

2. The air filter as claimed in claim 1, wherein said different-colored districts of said indicating plate are respectively provided with red color, yellow color and green color.

3. The air filter as claimed in claim 1, wherein said indicating plate is disk-shaped.

4. The air filter as claimed in claim 1, wherein said peep hole is arc-shaped.

5. The air filter as claimed in claim 1, wherein said peep hole is covered with a transparent protective plate fixed in position by bolts.
